(19) United States
(12) Patent Application Publication
(10) Pub. No.: US 2026/0358875 A1
(43) Pub. Date: Nov. 12, 2026

(54) STORAGE CIRCUITRY

(71) Applicant: Arm Limited, Cambridge (GB)

(72) Inventors: Edward Martin McCombs, JR., Austin, TX (US); Andrew David Tune, Dronfield (GB)

(21) Appl. No.: 19/205,194

(22) Filed: May 12, 2025

(51) Int. Cl. G06F 1/324

(52) U.S. Cl. CPC G06F 1/324

(57) ABSTRACT

There is provided an apparatus comprising storage circuitry arranged as a set-associative structure having a plurality of ways each operable in an accessible state in which data can be accessed and a low power state in which the data is retained in an inaccessible state. The apparatus comprises preamble tag storage circuitry to store a plurality of preamble tag entries each associated with a corresponding way and comprising a subset of bits of tag information. The apparatus comprises control circuitry responsive to receipt of lookup tag information to perform a preamble lookup. The control circuitry is responsive to one or more preamble hits on one or more preamble tag entries identifying one or more corresponding ways, to trigger a transition of the one or more corresponding ways to the accessible state, and to retain ways other than the one or more corresponding ways in the low power state.

### TECHNICAL FIELD

The present invention relates to data processing. More particularly the present invention relates to an apparatus, a system, a chip-containing product, a method, and a computer-readable medium.

### BACKGROUND

Some apparatuses are provided with storage circuitry arranged as a set-associative structure that is configured to store data to be looked up in response to receipt of lookup tag information. In order to determine whether the data is stored in a particular way of the set associative structure the lookup tag information is compared against tag information stored in each way of the storage structure.

### BRIEF SUMMARY

According to a first aspect of the present techniques there is provided an apparatus comprising: storage circuitry arranged as a set-associative structure having a plurality of ways, each of the plurality of ways operable in an accessible state in which data can be accessed and a low power state in which the data is retained in an inaccessible state; preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry; and control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.

According to a second aspect of the present techniques there is provided a system comprising: the apparatus according to the first aspect, implemented in at least one packaged chip; at least one system component; and a board, wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method of operating an apparatus comprising storage circuitry arranged as a set-associative structure having a plurality of ways, each of the plurality of ways operable in an accessible state in which data can be accessed and a low power state in which the data is retained in an inaccessible state, the method comprising: storing, in preamble tag storage circuitry, a plurality of preamble tag entries, each preamble tag entry associated with a corresponding way of the plurality of ways and comprising a subset of bits of tag information identifying the data stored in the corresponding way associated with that preamble tag entry; and in response to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, triggering a transition of the one or more corresponding ways to the accessible state, and retaining ways other than the one or more corresponding ways in the low power state.

According to a fifth aspect of the present techniques there is provided a non-transitory computer-readable medium storing computer-readable code for fabrication of an apparatus comprising: storage circuitry arranged as a set-associative structure having a plurality of ways, each of the plurality of ways operable in an accessible state in which data can be accessed and a low power state in which the data is retained in an inaccessible state; preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry; and control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates storage circuitry according to some configurations of the present techniques;

FIG. 3 schematically illustrates storage circuitry according to some configurations of the present techniques;

FIG. 4 schematically illustrates storage circuitry comprising a plurality of ways according to some configurations of the present techniques;

FIG. 5 schematically illustrates an apparatus according to some configurations of the present techniques;

FIG. 6 schematically illustrates an apparatus according to some configurations of the present techniques;

FIG. 7 schematically illustrates a tag preamble RAM and a tag prologue RAM according to some configurations of the present techniques;

FIG. 8 schematically illustrates a timing diagram according to some configurations of the present techniques;

FIG. 9 schematically illustrates a sequence of steps according to some configurations of the present techniques; and

FIG. 10 schematically illustrates a system and a chip containing product according to some configurations of the present techniques.

### DETAILED DESCRIPTION

Before discussing the configurations with reference to the accompanying figures, the following description of configurations is provided.

In some configurations there is provided an apparatus comprising storage circuitry arranged as a set-associative structure having a plurality of ways, each of the plurality of ways operable in an accessible state in which data can be accessed and a low power state in which the data is retained in an inaccessible state. The apparatus is provided with preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry. The apparatus is provided with control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.

Each way of the storage circuitry may be operable in a plurality of power states (otherwise referred to as power modes) including the low power state and the accessible state, however, in some configurations there may be plural accessible states and plural low power states. For example, the apparatus including the storage circuitry may be operable at a plurality of voltages and/or frequencies and, for each of the plurality of voltages and frequencies, each way of the storage circuitry may be operable in a corresponding accessible state and a corresponding low power state. In other words, the power state is controlled on a per-way basis. The accessible state is a state in which the data can be accessed. The operation of a particular way in the accessible state does not necessarily imply that content (e.g., data and/or instructions stored in the storage circuitry) is being accessed, rather that it is in a state in which it could be read from or written to. The low power state is a state in which the data cannot be directly accessed, i.e., it cannot be accessed whilst the way is in the low power state, but the data is retained such that it can subsequently be accessed once the way has transitioned to the accessible state. Therefore, in order to access content stored in a way that is in the low power state, that way must first be transitioned from the low power state to the accessible state.

Operating one or more ways in the low power state at a given time reduces the power consumed by the one or more ways at the given time reducing the power consumption of the apparatus. However, it may take one or more clock cycles to transition the one or more ways from the low power state to the accessible state increasing latency associated with accessing the content stored in the storage circuitry. Furthermore, for a given lookup address, it is not known which way will contain the data until the data tags associated with the ways have been read and compared against a lookup tag generated from the given lookup address. Hence, the tag data associated with each way needs to be read. Where the tag data associated with each way is stored in the storage circuitry, this requires each way to either be in the accessible state or to transition into the accessible state before the tag data can be read. Whilst it is possible to provide separate tag storage circuitry, such an approach would still require the tag data for all ways to be read, hence the tag storage circuitry would be required to either be in the accessible state or transition into the accessible state for all ways of the tag storage circuitry.

The inventors have recognized that it is possible to increase the total amount of time that the ways are in the low power state by storing a preamble tag entry comprising a portion of the tag in separate preamble tag storage circuitry. The preamble tag storage stores a preamble tag entry for each entry in the storage circuitry, i.e., there is a one-to-one correspondence between tag entries in the preamble tag storage circuitry and data entries in the storage circuitry. Each preamble tag entry stores a subset of the tag information. The subset is a proper subset, i.e., at least some information that is present in the tag information for a given entry is excluded from the preamble tag entry. For example, the preamble tag entry may exclude at least one bit of the tag information for a given entry. As a result, the preamble tag entries require less storage space (fewer bit cells) than the corresponding tag information. In general, the preamble tag entries comprise state information that can be used to eliminate one or more ways from the set of ways that could potentially store data associated with the lookup tag. In some configurations the preamble tag entries may comprise fewer than half the bits of the tag information or fewer than a quarter of the bits of tag information. The preamble tag information may comprise specific bits of the tag information or may be generated from a lossy hash of the tag information. In some configurations the preamble tag information may comprise one or more duplicated bits of the tag information and/or one or more valid bits indicative of whether the corresponding data is valid. Reusing duplicated portions of the tag information reduces the complexity of the design. In some configurations, the tag information may comprise only the valid bit. Because the preamble tag information is stored in the preamble tag storage circuitry which is separate from the storage circuitry, the preamble tag entries can be compared against a preamble portion of a lookup tag without causing any of the ways of the storage circuitry to transition into the accessible state. This reduces the power consumption of the storage circuitry without requiring the storage of full tag information in separate tag storage circuitry.

The apparatus is provided with control circuitry that is responsive to receipt of lookup tag information to perform preamble lookup in which the control circuitry compares a preamble portion of the lookup tag against corresponding preamble portions of the tag information stored in the preamble tag storage circuitry. The preamble portion of the lookup tag is generated from the lookup tag in the same way as the preamble entries are generated from the tag information (e.g., using a lossy hash function or through selection of a proper subset of bits of the lookup tag). Because the preamble portion excludes at least some of the tag information, the preamble lookup may result in both true hits and false hits (i.e., some of the lookup tag information matches some of the stored tag information). The preamble lookup cannot result in false misses. The preamble lookup may therefore result in one or more preamble hits (which may include a single true hit and/or one or more false hits). Each of the preamble hits identifies a corresponding way in the storage circuitry. The control circuitry is responsive to the preamble hits to trigger the corresponding ways to transition into the accessible state. The transition may be a transition from the low power state, or from any other state, for example, if the way is already in the accessible state, the control circuitry will cause the way to remain in the accessible state, e.g., a trigger may be issued from the control circuitry and discarded by power management circuitry if it is determined that the way is already in the accessible state. The control circuitry will also trigger ways other than the one or more corresponding ways (i.e., the ways for which the preamble lookup resulted in a miss) to remain in the low power state. As a result, the number of ways that are retained in a low power state during a lookup can be increased and, as a result, the overall power consumption of the apparatus is reduced. Where the preamble lookup results in no hits, the control circuitry is able to retain all ways in the low power state.

In some configurations the apparatus comprises prologue tag storage circuitry associated with each corresponding way and configured to store prologue tag entries, each prologue tag entry comprising a further subset of bits of the tag information identifying the data stored in the corresponding way associated with that prologue tag entry, wherein the control circuitry is configured, for each one of the one or more corresponding ways, to perform a prologue lookup in the prologue tag storage circuitry associated with that one of the one or more corresponding ways based on a prologue portion of the lookup tag information. Each prologue tag entry corresponds to a preamble tag entry and a data entry in the data storage circuitry. There is a one-to-one relationship between the prologue tag entries and the preamble tag entries. There is also a one-to-one relationship between the prologue tag entries and the entries in the data storage circuitry such that each entry in the data storage circuitry has a corresponding preamble tag entry and a corresponding prologue tag entry. Subsequent to the preamble lookup, the control circuitry is configured to perform one or more prologue lookups to determine if a prologue portion of the tag information matches a prologue portion of the lookup tag information. However, for preamble tag lookups which resulted in a miss, the control circuitry is already able to exclude the way associated with those preamble tags and, hence, the control circuitry is able to omit performing a prologue lookup for prologue entries associated with those preamble tags. Where the preamble lookup results in no hits, the control circuitry is able to completely omit the prologue lookup resulting in a further power saving. The prologue lookups may be performed in parallel with one another or in sequence with one another dependent on the particular arrangement of read circuitry provided for the prologue storage circuitry. Where sequential prologue lookups are performed, a hit on a prologue entry may trigger the control circuitry to suppress any subsequent ones of the sequential prologue lookups.

The data associated with the tag information may be accessed in a variety of ways. In some configurations the control circuitry is responsive to the prologue lookup resulting in a prologue hit on a single way of the one or more corresponding ways, to trigger corresponding data associated with the lookup tag information to be accessed from the single way. The data may be read out from the storage circuitry subsequent to the prologue lookup. Alternatively, the data may be read out from the storage circuitry to one or more buffers in parallel to the prologue tag entry being read. The data may then be read out from the buffer in response to the hit on the prologue tag entry.

Furthermore, in some configurations the control circuitry is responsive to the prologue lookup resulting in the prologue hit, to trigger ways of the one or more corresponding ways other than the single way to transition to the low power state. For example, in scenarios where the preamble lookup resulted in a plurality of preamble hits, ways associated with each of those preamble hits may transition from the low power state to the accessible state. Subsequent to the prologue lookup it may be determined that some, or all, of those ways resulted in a prologue miss. As a result, those ways that missed in the prologue lookup are not required and the control circuitry may cause those ways to transition back to the low power state.

In some configurations the control circuitry is configured to trigger the transition prior to completion of the prologue lookup. In other words, the transition triggered by the control circuitry in response to the preamble lookup resulting in one or more preamble hits may be triggered before the completion of the prologue lookup. In some configurations the transition may be completed prior to beginning the prologue lookup. For example, in some configurations the prologue tag storage circuitry forms part of the data storage circuitry and the prologue lookup cannot be performed for a way until that way has transitioned to the accessible state. In other configurations the prologue tag storage circuitry may be separate from the data storage circuitry and at least a portion of the prologue lookup may be performed before the data storage circuitry has transitioned into the accessible state.

The prologue tag portion may be any portion of the tag. In some configurations, for a given data item, a combination of the preamble tag information and the prologue tag information uniquely identify the tag information for the given data item. The prologue tag information may comprise the entire tag information such that the prologue tag lookup alone can uniquely identify a hit on a given entry in the data storage circuitry. In some configurations, the prologue tag information and the preamble tag information are each subsets of the full tag information such that neither can result in a unique hit, however, the union of the preamble tag information and the prologue tag information comprises the full tag information and can uniquely determine whether the data associated with lookup tag information is present in the data storage circuitry. In some configurations the preamble tag portion of a given tag and the prologue tag portion of the given tag are non-overlapping subsets of the given tag. In some configurations the preamble tag portion of the given tag and the prologue tag portion of the given tag are at least partially overlapping tag portions of the given tag.

The timing of the preamble lookup and the prologue lookup can be variously defined. In some configurations the preamble lookup is performed during a sequentially first clock cycle and the prologue lookup is performed in a sequentially second clock cycle. Alternatively, the preamble and prologue lookups may be triggered during a same clock cycle, for example, where prologue tag storage circuitry is provided as separate circuitry to the data storage circuitry. The preamble lookup may be performed quicker and complete in advance of the prologue lookup. In some configurations the preamble lookup is performed in a the sequentially first clock cycle and the transition is triggered as soon as the preamble lookup is completed. For example, the transition may be triggered before a rising edge of the clock cycle subsequent to the sequentially first clock cycle.

In some configurations the first clock cycle and the second clock cycle are consecutive clock cycles. In some alternative configurations the first clock cycle and the second clock cycle are non-consecutive clock cycles.

Whilst the prologue lookup may be performed independent from accessing data stored in the data storage circuitry in association with the tag information, in some configurations the control circuitry is configured to trigger corresponding data associated with the lookup tag information to be read from the way in the sequentially second clock cycle. In other words, the corresponding data is read from the data storage circuitry during a same read cycle as the prologue tag information. In some configurations the prologue tag information and the data associated with the prologue tag information are stored in adjacent bit-cells within the data storage circuitry, i.e., they are stored in a same tag RAM and are accessed in response to a same read signal.

In some configurations the control circuitry is configured to trigger the transition in the sequentially second clock cycle. The transition of the one or more corresponding ways to the accessible state may be a first portion of the prologue lookup and may be performed in parallel with one or more other portions of the prologue lookup.

In some configurations the storage circuitry is configured to trigger each way to transition into the low power state in response to a predetermined condition being met. The predetermined condition may be met in response to the prologue lookup being completed and, in the event of the prologue lookup resulting in a hit, data associated with the prologue lookup being returned.

In some configurations the predetermined condition is met when the given way is not accessed for a predetermined number of clock cycles. Hence, subsequent to transitioning to the accessible state, each way may remain in that state for the predetermined number of clock cycles. This approach reduces the likelihood that a given way will repeatedly switch between different power states.

In some configurations the apparatus is arranged as a cache. For example, the cache may be a data cache or an instruction cache. The cache may be provided at one of a plurality of possible cache levels within a data processing system. For example, the cache may be a level one cache associated with a particular processing pipeline, or may be a lower level cache shared between a plurality of processing pipelines and or other processing circuits. The cache may be a translation lookaside buffer (TLB) cache, which caches address translation information obtained based on page tables stored in a memory system, or a branch prediction cache which holds branch prediction information for predicting branch outcomes.

In some configurations the cache is a snoop filter. A snoop filter cache caches presence information identifying whether or not one or more caches subject to a coherency protocol hold a valid cache entry corresponding to a given address. The presence information may be implemented in a variety of ways. For example, in an exclusive snoop filter, the presence information identifies caches that do not hold a valid cache entry for the given address and so can be omitted from being snooped in response to a load/store request for the given address. As a further example, the snoop filter may be implemented as an inclusive snoop filter in which the presence information identifies caches that do hold a valid cache entry for the given address. Hence, a miss in an inclusive snoop filter would mean that the cache line associated with the given address is not held in any of the caches and snoop requests for the given address can be omitted for each of the caches. In some configurations the preamble tag information may be generated from a logical combination of the presence information. For example, in the preamble tag information may be a logical OR of the presence information indicating whether some or no presence information is present.

The transition between the power states may be performed in a variety of ways. In some configurations the control circuitry is configured to trigger the transition of a given way from the low power state to the accessible state by modifying a power supply parameter associated with the given way. Modifying the power supply parameter may comprise modifying a voltage and/or frequency at which the way is operated. The transition from the low power state to the accessible state may include increasing an operation voltage of the way, enabling one or more clock gates associated with read circuitry associated with the way and/or enabling one or more power gates associated with read circuitry associated with the way. The power supply parameter may be a relative power supply parameter relative to a power supply parameter associated with read circuitry associated with the apparatus, e.g., a power supply parameter of the control circuitry, which may also be modified by one or more external parameters such as a preference of higher privileged software and/or a throughput metric associated with processing circuitry associated with the apparatus.

Particular configurations will now be described with reference to the figures.

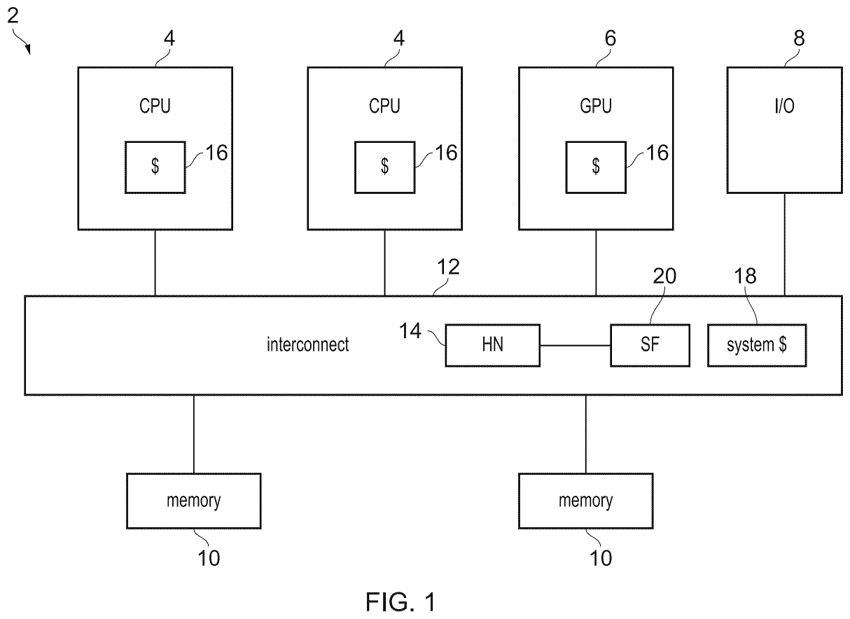

FIG. 1 illustrates an example of a data processing system 2, such as a system on chip implemented on a single integrated circuit or a packaged collection of two or more chiplets (separate integrated circuits implementing respective portions of the system 2, which are integrated into a same semiconductor package). The system 2 includes a number of memory access requesters 4, 6, 8 which share access to a shared memory 10, accessible via a memory system interconnect 12. The access requesters can include various processors, e.g. central processing units (CPUs) 4 or graphics processing units (GPUs) 6, and input/output (I/O) devices 8. Some of the access requesters 4, 6 may have their own private data caches 16 for caching load/store data obtained from the memory system 10. The private data caches 16 of the requesters 4, 6 may be subject to a coherency protocol managed by home node circuitry 14 within the interconnect 12, to ensure data coherency where when one requester 4, 6, 8 requests access to data for a given address, the requester receives the most up to date value of data for that address, which may sometimes be dirty data which another requester has updated in its own private cache 16. The interconnect 12 may also have a shared system cache 18, shared between multiple requesters, for caching load/store data from memory 10. While not shown in FIG. 1, other types of caches could also be provided, such as TLBs (translation lookaside buffers) provided in the CPU 4 or GPU 6 for caching address translation information for controlling virtual-to-physical address translation, or branch prediction caches for caching branch prediction information derived from previously detected branch outcomes, used for predicting branch outcomes for future branch instructions.

One type of cache that may be provided in the system 2 is a snoop filter 20 used by the home node circuitry 14 of the interconnect 12 to filter snoop traffic used to implement the coherency protocol for maintaining coherency between data cached in the respective private caches 16. The home node circuitry 14 implements a given coherency protocol, which defines a set of cache coherence transaction types and response protocols associated with those transaction types. Each address may, with respect to a particular requester 4, 6, be considered to be held in that requester's private cache 16 in a particular coherency state. For example, the coherency state may specify, with respect to a given address and a given requester 4, 6, whether valid data for that address is held at the given requester's private cache 16, and if valid data is held, whether that data is clean or dirty, and/or is held in an exclusive (unique) or shared state (exclusive data being held exclusively in that requester's private cache 16, and not in other requesters'private caches 16, while shared data is capable of being held in private caches of two or more requesters simultaneously). When data is held in an exclusive state, the requester holding the data as exclusive is allowed to write to the data in the cache without first issuing coherence transactions to check with the home node 14 whether other requesters could also be holding the data. When the data is held in a shared state, any write to the shared data in a given requester's private cache would require first issuing a coherence transaction to check with the home node 14 whether there are conflicting copies in other caches 16 (e.g. that coherence transaction may typically be a request that the data in the given requester's private cache 16 is upgraded to the exclusive coherency state, which may cause the home node 14 to send snoop requests to other requesters that could be holding that data, to trigger invalidation of data from those requesters'private caches 16).

The snoop filter 20 is provided for tracking (at least partially) information identifying which data addresses have corresponding data cached at certain requester's private caches 16. The snoop filter 20 may be implemented, for example, as an inclusive snoop filter or an exclusive snoop filter. Dependent on the implementation, the snoop filter 20 may contain data associated with the data address or may only contain information identifying the coherency state of the data (cache line), e.g., presence information associated with the address, and may not contain the data itself. The snoop filter can be used to reduce snoop traffic by allowing the home node circuitry 14 to determine when data is not cached at a particular requester. The snoop filter 20 can itself be regarded as a type of cache, since it has entries which can be allocated for corresponding addresses, and hold “cached data” for that address, but unlike the data caches 16, 18 for which the cached data is load/store data read from memory following a load operation or written to memory by a store operation performed by a given requester, the cached data in the snoop filter is snoop filter information (“presence” information) indicative of which private caches 16 may hold valid entries for the associated address. The snoop filter information in the snoop filter 20 may be updated based on detecting transitions of cache coherency state for associated cache lines in the requester caches 16. For example, in response to a request from a requester 4, 6 to allocate of a cache line for a given address into its private cache 16, the snoop filter 20 may update the snoop filter information for the given address to indicate that the cache line is now held in that private cache 16. If an access from one requester causes the home node 14 to send snoops to other requesters to request invalidation of a cache line corresponding to a given address, the home node 14 can control the snoop filter 20 to update the snoop filter information for that given address to indicate that those other requester's caches 16 no longer hold the data for the given address. The snoop filter information held in the snoop filter 20 can be imprecise, in that false positives may be possible where the snoop filter 20 indicates a given private cache 16 holds the data for a given address, but actually that private cache 16 has already silently evicted the data for the given address without informing the interconnect 12.

On receiving a request for a given address from one requester 4, 6 which may potentially require other requester's caches 16 to be snooped, the snoop filter 20 can be looked up based on the given address to identify whether there is any valid entry of the snoop filter 20 corresponding to the given address. If a hit is detected, the snoop filter information in the hit snoop filter entry is used to filter which other requester's caches 16 are sent snoops, and snoops can be suppressed for a requester's cache 16 which is indicated by the snoop filter information as not holding the cache line corresponding to the given address. If a miss is detected in the snoop filter 20, then no information is available on whether the line is present at the requesters 4, 6, which could be interpreted in different ways. For an exclusive snoop filter, and on a miss in the snoop filter the home node 14 may default to broadcasting snoops to all requesters 4, 6 which could potentially hold the cache line corresponding to the given address. For an inclusive snoop filter, on a miss in the snoop filter, the home node 14 may assume that the cache line corresponding to the given address is not held in any of the requester caches 16 and so may avoid sending snoop requests to any of the requester caches 16. Either type of snoop filter (inclusive or exclusive) could be used as the snoop filter 20.

In some cases (e.g., where the snoop filter 20 is an exclusive snoop filter), the snoop filter 20 may be combined with the shared system cache 18 so that a single lookup process for querying a combined data structure returns both any cached load/store data associated with the system cache 18 and associated snoop filter information associated with the snoop filter 20 which can be used to identify any requesters 4, 6 that are known not to be holding valid cached data for the associated address (and so do not need to be snooped when another requester accesses the same cache line). Alternatively, for example, where an inclusive snoop filter is provided, the snoop filter information associated with the snoop filter 20 can be used to identify any requesters 4,6 that are known to be holding valid cached data for the associated address (and so do need to be snooped when another requester accesses the same cache line).

Hence, the snoop filter 20 is an example of an included in a data processing system, and the techniques discussed below can be applied to the snoop filter 20 (where the “cached data” mentioned in the subsequent examples can include the snoop filter information which provides information on which private caches 16 hold a cache line for an associated address). However, it will be appreciated that the techniques discussed below can also be used for other types of caches.

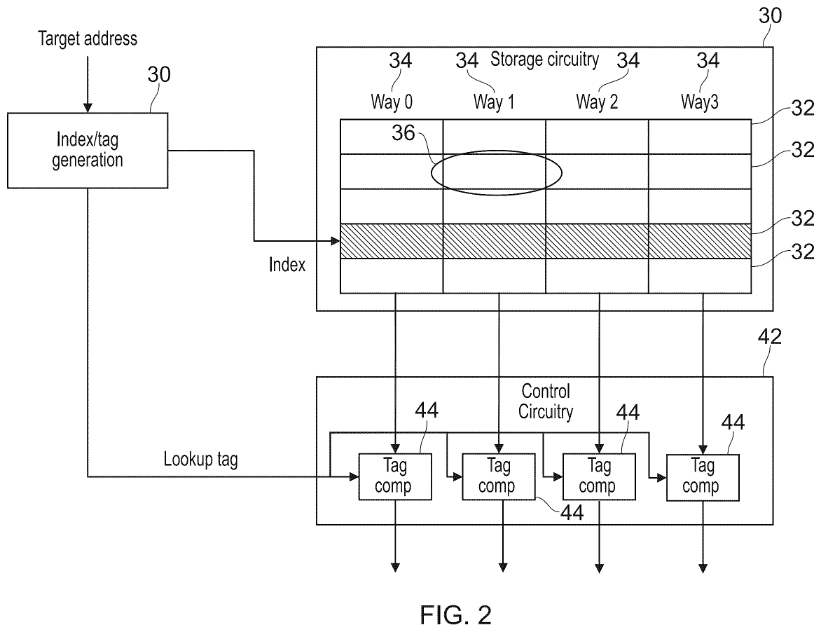

FIG. 2 shows a logical view of a cache, such as the data caches 16, 18 or snoop filter 20 mentioned earlier. The cache has storage circuitry 30 which comprises a number of cache entries 36 logically arranged as a number of cache sets 32 each comprising a number of ways 34. The number of ways per set is referred to as the “associativity” of the cache. In this example, the associativity is 4, so this is a 4-way set-associative cache where each set 32 comprises four ways 34. It will be appreciated that other examples could have a different associativity.

Each cache entry 36 logically comprises at least a valid indicator V indicating whether the cache entry is valid, a cache tag used to determine which address corresponds to the cache entry 36, and cached data which represents the functional information held in the cache that is useful for components outside the cache (in contrast, the valid indicator V and cache tag may be of interest internally within the cache for purposes of cache lookup, but are not of interest to the wider system). For example, the cached data can be the snoop filter information for the snoop filter 20 as discussed above.

When looking up the cache to check whether the cache holds a cache entry 36 corresponding to a target address, index/tag generation circuitry 40 generates an index value and lookup tag based on the target address. In some examples, the index and lookup tag could simply be respective portions of bits extracted from the target address. In other examples, the index/tag generation circuitry 40 may generate the index value by applying an index hash function to an index portion of bits extracted from the target address, and/or generate the lookup tag by applying a tag hash function to a tag portion of bits extracted from the target address.

The index value selects which set 32 is to be accessed for the target address. Hence, each address can have its cached data assigned to any entry (way) within the selected set 32 identified by the index value, and cannot have its cached data assigned to entries in other sets 32.

Tag lookup circuitry 42 reads out the cache tags for the respective entries (ways) 34 of the selected set 32 identified by the index value, and has a set of comparators 44 for comparing the lookup tag derived from the target address with the read out cache tags for each way, to identify for each way whether the lookup tag matches the cache tag. A hit signal is generated for each way, indicating a hit for a way where the lookup tag matches a cache tag, or a miss for any way where the lookup tag does not match the cache tag. The hit signals can be used to determine (i) whether the overall lookup hits or misses, and (ii) for a hit, which way's cached data should be returned in response to the cache lookup.

While FIG. 2 shows the index/tag generation logic 40 as separate from the tag lookup circuitry 42, other examples may treat the set/index tag generation logic as part of the tag lookup circuitry 42.

FIG. 2 shows a logical view of a set-associative cache structure. However, the physical implementation of the cache, implemented using one or more cache RAM arrays comprising bitcells storing bits according to a particular memory storage technology such as SRAM (static random access memory), may be different to the logical view. For example, the contents of a given logical cache entry 36 could be distributed over multiple cache RAMs. Hence, it will be appreciated that logical diagrams showing cache organization at a high level do not necessarily show how the logical functionality of storing cache entries and looking up cache entries would be implemented in physical circuitry. It is also possible that different cache RAMs used to store parts of the logical cache entry may use different index functions (e.g. where the cache is a skewed-associative cache, which uses different index functions for different ways of the cache set; or a cuckoo cache in which the tags are split into two or more banks with each addressed using a different index function).

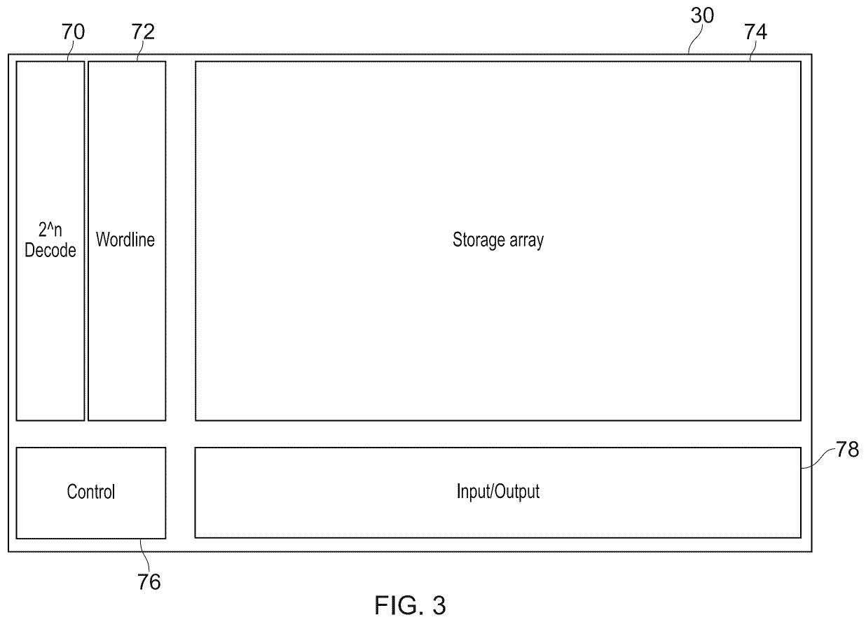

FIG. 3 schematically illustrates an example of circuitry provided for a cache 30 according to some configurations of the present technique. The cache includes:
a storage array 74 comprising an array of bitcells implemented as a two-dimensional matrix arranged in rows and columns. Each bitcell of the storage array 74 stores a single bit of stored state, according to a memory storage technology such as static random access memory (SRAM).
control circuitry 76 for controlling other components of the cache RAM array 30;
a row decoder 70 for decoding which row of bitcells is to be read/written in a read/write operation;
a wordline driver 72 for driving a wordline corresponding to the selected row of bitcells selected by the row decoder 70;
input/output logic (e.g. read/write drivers and input/output buffers) 78 for controlling readout of data from the storage array 74 on a read operation and input of write data to the storage array 74 on a write operation. For example, the access logic can include:
   bitline drivers for driving bitlines for respective columns of the array with values corresponding to write data to be written to the active row during a write operation,
   sense amplifiers for reading out the values on the bitlines corresponding to the read data read from the active row during a read operation;
   in some examples, ECC (error correction code) computation/checking circuitry for computing an ECC for the selected row on a write operation, and performing ECC checking to generate an error syndrome value based on the stored ECC and other contents of the row on a read operation (where the error syndrome value is a value indicative of whether the ECC corresponds to the read contents of the row). It is not essential for ECC computation/checking circuitry to be integrated into the cache RAM array 30. Other examples could use external ECC computation/checking circuitry outside the cache RAM array to compute an ECC to be written as part of the write data to a row of bitcells in the storage array 74, and to generate the syndrome value and perform other parts of ECC checking operations for checking whether an ECC error has occurred and, if possible, correcting the error.
   input/output (I/O) buffers which receive write data from a write requesting circuit component for a write operation, and output read data read out by a read/write driver for a read operation to a downstream circuit component, such as tag lookup circuitry in the case when tags are being read out from the cache RAM for tag comparisons.

The storage array 74, along with the corresponding input/output circuitry 78 may be provided for both the data storage circuitry and the preamble tag storage circuitry. Hence, a separate storage array or portion of the storage array may be provided for the preamble storage circuitry.

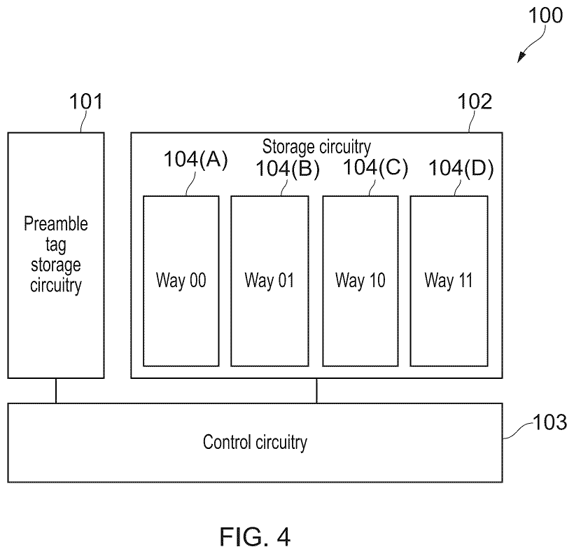

FIG. 4 schematically illustrates an apparatus 100 according to some configurations of the present techniques. The apparatus 100 is provided with control circuitry 103, storage circuitry 102, and preamble tag storage circuitry 101. The storage circuitry 102 is arranged as a set associative storage circuit comprising a plurality of ways 104. In the illustrated configuration four ways 104 are provided including way 00 104(A), way 01 104(B), way 10 104(C), and way 11 104(D). However, it will be readily apparent that the number of ways is implementation dependent and a smaller or greater number of ways 104 may be provided in different configurations. Each of the ways 104 is configured to store data and is operable in a plurality of states including an accessible state in which the data can be accessed and a low power state in which the data is inaccessibly retained, i.e., the data is retained so that, whilst it cannot be accessed in the low power state, if one or more of the ways 104 transitions to the accessible state, then the data in that way is accessible.

The preamble tag storage circuitry 101 is provided to store preamble tag entries. Each of the preamble tag entries is associated with a corresponding storage location in the storage circuitry 102. In particular, there is a one-to-one relationship between the preamble entries and data storage entries in the storage circuitry 102. Each preamble entry stores a subset of bits of tag information identifying the data stored in the corresponding way associated with that preamble tag entry. As a result, a lookup in the preamble tag storage circuitry 101 using a preamble portion of a lookup tag, may result in a miss indicating that there is no data associated with that lookup tag in the storage circuitry 102. Alternatively, the lookup may result in one or more hits, each of the hits indicates that data associated with the lookup tag may be stored in the storage circuitry 102. For example, the one or more hits may comprise one or more false hits and/or a single true hit.

The control circuitry 103 is responsive to receipt of lookup tag information to perform a preamble lookup in the preamble tag storage circuitry 101 using a preamble portion of the lookup tag information. The preamble lookup may be performed for a single index value identified by a lookup index. The control circuitry 103 is responsive to one or more preamble hits on one or more preamble tag entries identifying one or more corresponding ways 104 in the storage circuitry to trigger a transition of the one or more corresponding ways to the accessible state, and to retain ways 104 other than the one or more corresponding ways in the low power state such that the data in those ways is retained but is not read out of the storage circuitry 102.

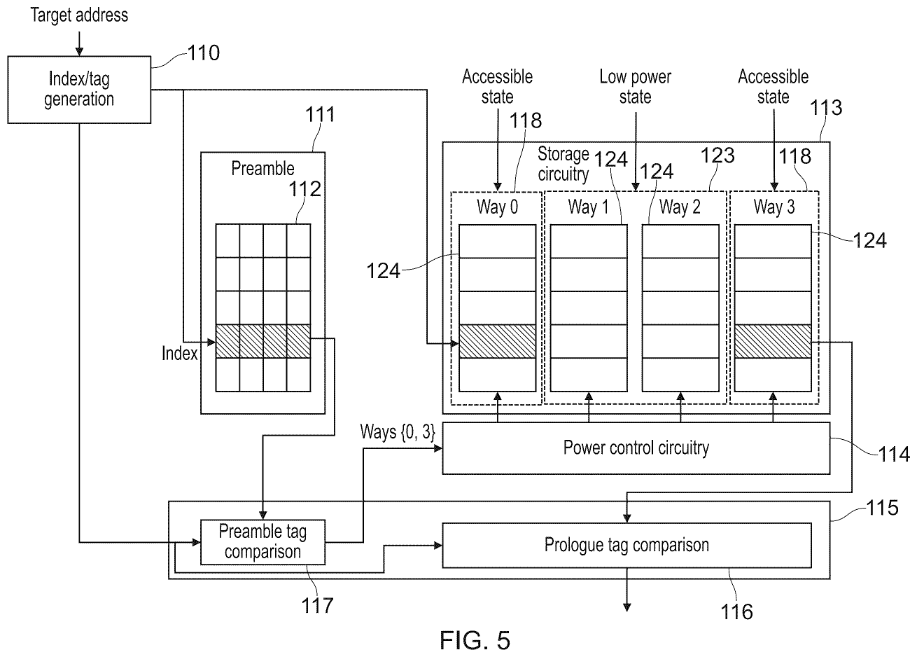

FIG. 5 schematically illustrates an apparatus according to some configurations of the present techniques. The apparatus is provided with index/tag generation circuitry 110, storage circuitry 113, preamble tag storage circuitry 111, control circuitry 115, and power control circuitry 114. The storage circuitry 113 is configured as a set associative storage structure having a plurality of ways 124. Each entry in the storage circuitry 113 stores both the prologue tag portion of a tag identifying the entry, and the data associated with that prologue tag portion.

The index/tag generation circuitry 110 is responsive to receipt of a target address to generate a lookup index portion of the address and a lookup tag portion of the address. For example, the lookup index portion may be a less significant portion of the lookup address (e.g., a least significant portion of the address on a cache line level of granularity) and the tag portion may be a more significant portion of the lookup address (e.g., the most significant portion of the lookup address excluding the index portion). Alternatively, the tag portion may be the entire lookup address or the entire lookup address on a cache line level of granularity. The lookup index portion of the lookup address is output from the index/tag generation circuitry 110 to the preamble tag storage circuitry 111 and to the storage circuitry 113. The lookup tag portion of the lookup address is provided from the index/tag generation circuitry 110 to the control circuitry 115.

The preamble tag storage circuitry 111 stores a plurality of preamble entries 112. The preamble entries 112 have a one-to-one correspondence with the entries in the storage circuitry 113. In the illustrated configuration the storage circuitry 113 is provided with four ways 124 each provided with a plurality of rows. The preamble tag storage circuitry 111 stores preamble entries 112 arranged in a matrix having four columns, one for each of the plurality of ways 124 and a plurality of rows, one for each of the plurality of rows of the ways 124. The lookup index portion identifies a unique row of the preamble entries 112 corresponding to a same row in each way 124 of the storage circuitry 113. The preamble entries associated with the lookup index are read out and provided to the control circuitry 115.

The control circuitry 115 is provided with preamble tag comparison circuitry 117 which receives the lookup tag portion and the preamble entries from the preamble tag storage circuitry 111. The preamble tag comparison circuitry 117 generates a preamble lookup tag portion and compares the preamble lookup tag portion against the preamble tag entries retrieved from the preamble tag storage circuitry 111. When one or more hits are identified in the preamble tag comparison circuitry 117, an indication of ways associated with the entries that hit is passed to the power control circuitry 114. In the illustrated configuration, it is assumed that ways 0 and 3 resulted in a preamble hit and ways 1 and 2 resulted in a preamble miss. Information identifying the ways that resulted in preamble hits (ways 0 and 3) is passed to the power control circuitry 114, although it will be readily apparent to the person of ordinary skill in the art that in alternative configuration the information passed to the power control circuitry 114 could be information identifying the ways that resulted in preamble misses. At this stage, it is not yet determined whether the preamble hits on ways 0 and 3 are true hits or false hits.

The power control circuitry 114 receives the information identifying the ways that resulted in preamble hits and causes the identified ways to transition to the accessible state. The signal to trigger the transition may be passed as soon as the preamble tag comparison has been completed, i.e., prior to a rising edge of a next clock cycle triggering the prologue tag comparison. In particular, way 0 and way 3 are transitioned to the accessible state 118. The remaining ways (ways 1 and 2) are held in the low power state 123. As a result, ways 0 and 3 can be accessed and ways 1 and 2 cannot. The storage circuitry 113 is provided with the lookup index which identifies a row in the storage circuitry and ways 0 and 4 are read from the identified row. The information stored in the ways includes the prologue tag portion and associated data. This information is passed to the control circuitry 115 which comprises prologue tag comparison circuitry 116.

The prologue tag comparison circuitry 116 receives the lookup tag and the information retrieved from the storage circuitry 113. The prologue tag comparison circuitry 116 generates a prologue portion of the lookup tag and compares it against the prologue tags from the accessible ways to determine if the preamble hits that resulted in those ways being accessible were true hits or false hits. In the event of a true hit, the data associated with the prologue tag portion that resulted in the true hit, is output. In the event of a miss, the data is not output.

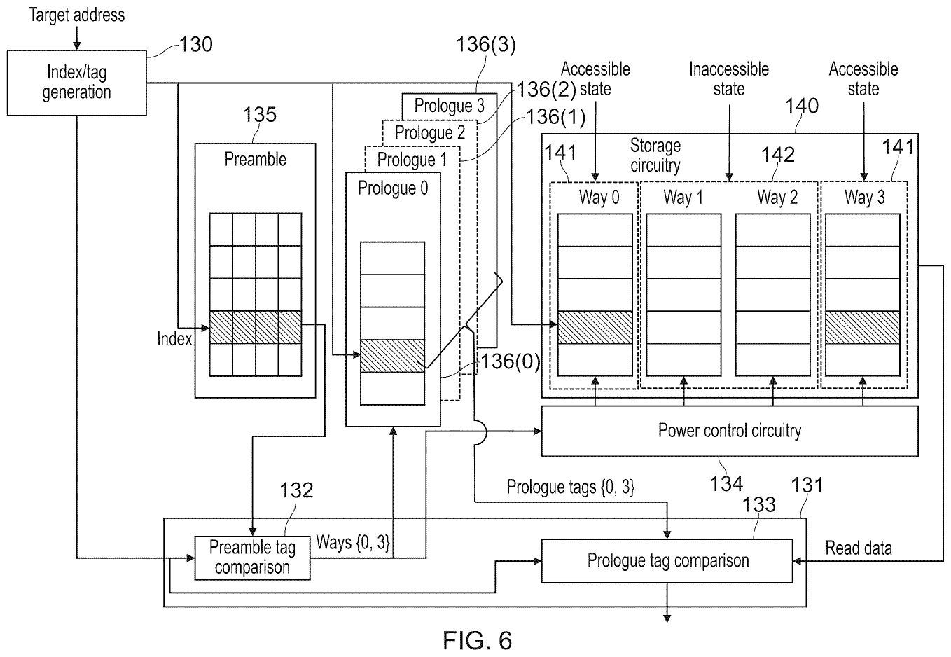

FIG. 6 schematically illustrates an apparatus according to some configurations of the present techniques. The apparatus is provided with index/tag generation circuitry 130, preamble tag storage circuitry 135, prologue tag storage circuitry 136, storage circuitry 140, power control circuitry 134, and control circuitry 131. The storage circuitry 140 is arranged as a set associative storage structure having a plurality of ways. Each entry in the storage circuitry 140 has a one-to-one correspondence with a preamble entry in the preamble tag storage circuitry 135 and a prologue entry in the prologue tag storage circuitry 136. The entries in the storage circuitry 140 comprise data associated with the prologue tag in the prologue storage circuitry 136 and associated with the preamble tag in the preamble storage circuitry corresponding to that entry in the storage circuitry 140. In other words, the tag information is stored in separate tag RAMs from the data.

The index/tag generation circuitry 130 is responsive to receipt of a target address to generate a lookup index portion of the address and a lookup tag portion of the address. The lookup index portion of the lookup address is output from the index/tag generation circuitry 110 to the preamble tag storage circuitry 135, to the prologue tag storage circuitry 136, and to the storage circuitry 140. The lookup tag portion of the lookup address is provided from the index/tag generation circuitry 130 to the control circuitry 131.

The preamble tag storage circuitry 135 stores a plurality of preamble entries. The preamble entries have a one to one correspondence with the entries in the storage circuitry 140. As in FIG. 5, the storage circuitry 140 is provided with four ways each provided with a plurality of rows. The preamble tag storage circuitry 135 stores preamble entries arranged in a matrix having four columns, one for each of the plurality of ways and a plurality of rows, one for each of the plurality of rows of the ways. The lookup index portion identifies a unique row of the preamble entries corresponding to a same row in each way of the storage circuitry 140. The preamble entries associated with the lookup index are read out and provided to the control circuitry 131.

The control circuitry 131 is provided with preamble tag comparison circuitry 132 which receives the lookup tag portion and the preamble entries from the preamble tag storage circuitry 135. The preamble tag comparison circuitry 132 generates a preamble lookup tag portion and compares the preamble lookup tag portion against the preamble tag entries retrieved from the preamble tag storage circuitry 135. When one or more hits are identified in the preamble tag comparison circuitry 132, an indication of ways associated with the entries that hit is passed to the power control circuitry 134 and to the prologue tag storage circuitry 136. The signal to trigger the transition may be passed as soon as the preamble tag comparison has been completed, i.e., prior to a rising edge of a next clock cycle triggering the prologue tag comparison. In the illustrated configuration, it is assumed that ways 0 and 3 resulted in a preamble hit and ways 1 and 2 resulted in a preamble miss. Information identifying the ways that resulted in preamble hits (ways 0 and 3) is passed to the power control circuitry 134 and to the prologue tag storage circuitry 136. At this stage, it is not yet determined whether the preamble hits on ways 0 and 3 are true hits or false hits.

The power control circuitry 134 receives the information identifying the ways that resulted in preamble hits and causes the identified ways to transition to the accessible state. In particular, way 0 and way 3 are transitioned to the accessible state 141. The remaining ways (ways 1 and 2) are held in the low power state 142. As a result, ways 0 and 3 can be accessed and ways 1 and 2 cannot. The storage circuitry 140 is provided with the lookup index which identifies a row in the storage circuitry and ways 0 and 4 are read from the identified row. The information stored in the ways includes the data to be output in the event of a prologue hit. However, in contrast to FIG. 5, the data stored in the storage circuitry 140 does not include the prologue tag portion which is stored in the separate prologue tag storage circuitry 136. The data read out from the storage circuitry 140 is passed to the control circuitry 131 which comprises prologue tag comparison circuitry 133 which will be described below.

The prologue tag storage circuitry 136 comprises four separate tag RAMs: prologue tag storage circuitry 0 136(0), prologue tag storage circuitry 1 136(1), prologue tag storage circuitry 2 136(2), and prologue tag storage circuitry 3 136(3). Each of the prologue tag RAMs 136 is associated with a corresponding way in the storage circuitry 140. Each of the prologue tag RAMs 136 comprises a plurality of rows with each row corresponding to a row in the corresponding way of the storage circuitry 140. The lookup tag index is provided to the prologue tag RAMs 136 to identify the particular row associated with the target address. Information identifying the ways that resulted in a preamble hit is also passed to the prologue tag RAMs 136, in the illustrated configuration, this information identifies prologue tag storage circuitry 0 136(0) and prologue tag storage circuitry 136(3). The remaining prologue tag storage, i.e., prologue tag storage circuitry 1 136(1) and prologue tag storage circuitry 2 136(2) is not accessed and may be retained in a low power state. Prologue tag entries from the identified row in each of the accessed prologue tag storage circuits (prologue tag storage circuitry 0 136(0) and prologue tag storage circuitry 136(3)) are read out and passed to the prologue tag comparison circuitry 133.

The prologue tag comparison circuitry 133 receives the lookup tag, the prologue tags read out from the prologue tag storage circuitry 136, and the information retrieved from the storage circuitry 140. The prologue tag comparison circuitry 133 generates a prologue portion of the lookup tag and compares it against the prologue tags from prologue tag storage circuitry 136 to determine if the preamble hits that resulted in those prologue tag entries being accessible were true hits or false hits. In the event of a true hit, the data retrieved from the storage circuitry 140 that is associated with the prologue tag portion that resulted in the true hit, is output. In the event of a miss, the data is not output.

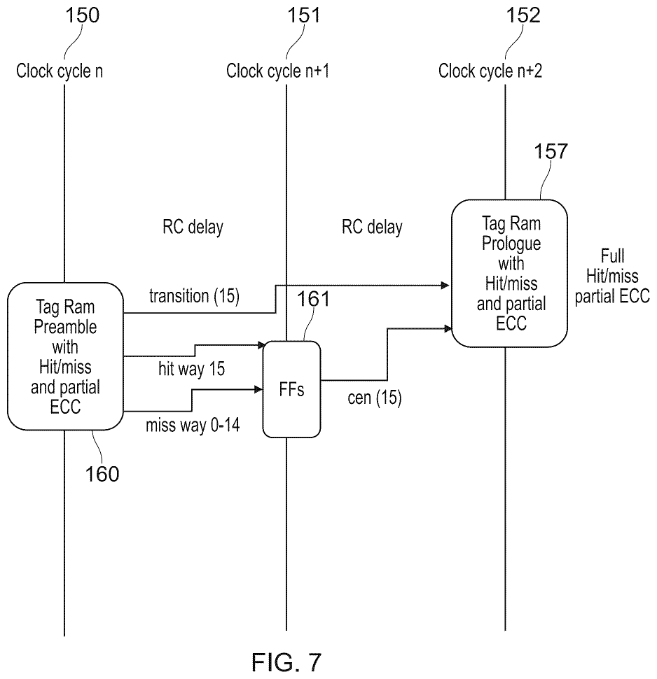

FIG. 7 schematically illustrates an example of a timing diagram associated with accessing the preamble and prologue storage circuitry in association with some configurations of the present techniques. The accesses occur over a sequence of clock cycles from clock cycle n 150 (where n is any integer), through clock cycle n+1 151 to clock cycle n+2 152. It is assumed that a lookup address has been received and a corresponding lookup index and lookup tag have been prepared.

In clock cycle n 150 a lookup is performed 160 in the preamble tag storage circuitry to determine if there are any preamble hits, i.e., partial hits which may turn out to be true hits or false hits. During the lookup partial ECC information may also be retrieved. There is an associated latency with this step due, at least in part, to the Resistance Capacitance (RC) delay associated with retrieving the information from the preamble tag storage circuitry. Hit information and miss information is propagated to storage circuitry 161 which comprises a plurality of Flip Flops (FFs) to store the information identifying the way(s) which resulted in a preamble hit. In the illustrated example, a preamble hit occurs in way 15 with preamble misses occurring in ways 0 to 14. At the same time a transition signal is passed to the prologue tag storage circuitry 157 to trigger way 15 to transition from the low power state to the accessible state. The transition to the accessible state can therefore be performed sooner, i.e., without waiting for the rising edge of clock cycle n+1 151.

In clock cycle n+1 151, information identifying the ways that hit and the ways that missed is stored in FFs 161. Subsequently, a chip enable (cen) signal identifying way 15 is issued to the prologue tag storage circuitry 157 which has now transitioned to the accessible state.

In clock cycle n+2 152, the prologue tag storage circuitry 157 is accessed and it is determined if the preamble hit(s) identified in the preamble tag storage circuitry resulted in a true hit or a true miss. During the lookup additional partial ECC information may be retrieved. In the event of a true hit, data associated with the prologue hit can be output, e.g., in one or more further clock cycles.

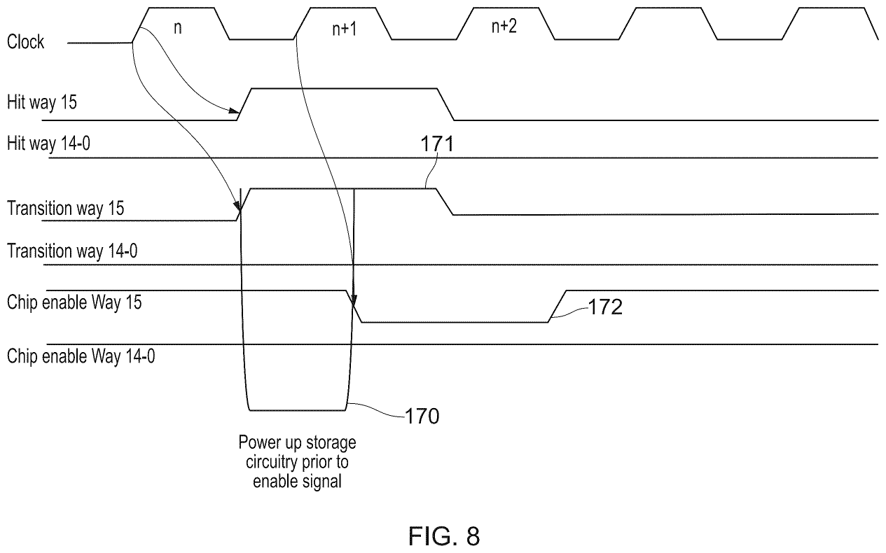

FIG. 8 schematically illustrates a timing diagram for the signals described in relation to FIG. 7. In particular, during clock cycle n 150 the preamble lookup is performed and it is identified that there is a preamble hit in way 15 (with a preamble miss in ways 0-14). Prior to the rising edge of clock cycle n+1 151, the preamble tag storage circuitry returns a hit signal on way 15 and a transition signal 171 is issued to trigger the prologue tag storage circuitry and/or the data storage circuitry to transition from the low power state to the accessible state. Subsequently, in clock cycle n+1 151, the chip enable signal is issued to enable a read from the storage circuitry and/or the prologue tag storage circuitry. Because the transition signal is issued before clock cycle n+1 151, there is a time window 170 in which the storage circuitry and/or the prologue tag storage circuitry is able to transition to the accessible state prior to the chip enable signal being asserted. As a result, the prologue tag storage circuitry and/or the storage circuitry is accessible sooner than it would otherwise have been, for example, if the transition had begun when on the leading edge of clock cycle n+1 151.

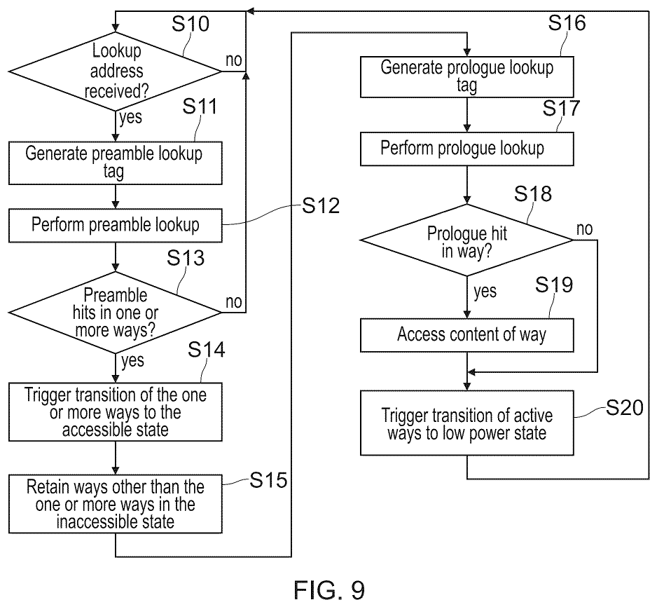

FIG. 9 schematically illustrates a sequence of steps carried out according to some configurations of the present techniques. Flow begins at step S10 where it is determined if a lookup address has been received, for example, from a requestor device. If, at step S10, it is determined that no lookup address has been received, then flow remains at step S10. If, at step S10, it is determined that a lookup address has been received, then flow proceeds to step S11 where a preamble lookup tag is generated from the lookup address. Flow then proceeds to step S12 where the preamble lookup is performed. Flow then proceeds to step S13 where it is determined whether the preamble lookup resulted in one or more preamble hits on one or more ways. If, at step S13, it is determined that the preamble lookup did not result in any preamble hits, then flow returns to step S10. If, at step S13, it is determined that the preamble lookup resulted in one or more preamble hits on one or more of the ways, then flow proceeds to step S14 where the one or more ways that resulted in the hit are transitioned from the low power state to the accessible state. Flow then proceeds to step S15 where ways other than the one or more ways that resulted in a hit are retained in the low power (inaccessible) state. Flow then proceeds to step S16 where a prologue lookup tag is generated from the lookup address. Flow then proceeds to step S17 where a prologue lookup is performed for each of the ways that resulted in a preamble hit. Flow then proceeds to step S18 where it is determined whether a prologue hit resulted from the prologue lookups. If, at step S18, it is determined that the prologue lookup resulted in a prologue hit, then flow proceeds to step S19 where the content of the way that resulted in the prologue hit is accessed. Flow then proceeds to step S20. If, at step S18, it was determined that the prologue lookup did not result in a hit, then flow proceeds to step S20. At step S20, the active ways, e.g., those that have transitioned to the accessible state, are triggered to transition to the inaccessible state. Flow then returns to step S10.

It will be readily apparent that the steps set out in FIG. 9 are not necessarily performed in the identified sequence and that the specific step ordering is provided for illustrative purpose only. For example, steps S14 to S16 may be performed in parallel, partially in parallel or in an alternative sequence. As a further example, steps S16 and S17 may be performed before steps S14 and S15 with S17 being performed after S16. It will also be readily apparent that the lookups performed may be for a specific lookup index with only the row of the storage circuitry associated with the lookup index being accessed in the preamble lookup and the prologue lookup. Furthermore, in some alternative configurations a subsequent preamble hit may occur prior to S20, in which case, one or more active ways may be retained in the accessible state without transitioning to the low power state.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

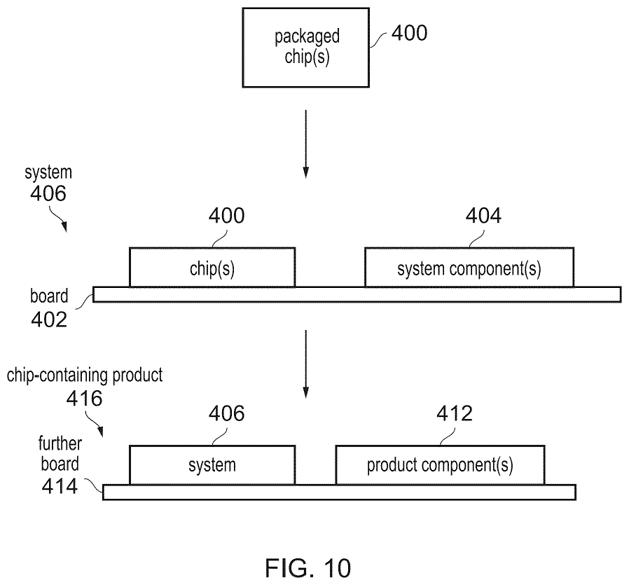

As shown in FIG. 10, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising storage circuitry arranged as a set-associative structure having a plurality of ways each operable in an accessible state in which data can be accessed and a low power state in which the data is retained in an inaccessible state. The apparatus comprises preamble tag storage circuitry to store a plurality of preamble tag entries each associated with a corresponding way and comprising a subset of bits of tag information. The apparatus comprises control circuitry responsive to receipt of lookup tag information to perform a preamble lookup. The control circuitry is responsive to one or more preamble hits on one or more preamble tag entries identifying one or more corresponding ways, to trigger a transition of the one or more corresponding ways to the accessible state, and to retain ways other than the one or more corresponding ways in the low power state.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:
Clause 1. An apparatus comprising: storage circuitry arranged as a set-associative structure having a plurality of ways, each of the plurality of ways operable in an accessible state in which data can be accessed and a low power state in which the data is retained in an inaccessible state; preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry; and control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.
Clause 2. The apparatus of clause 1, comprising prologue tag storage circuitry associated with each corresponding way and configured to store prologue tag entries, each prologue tag entry comprising a further subset of bits of the tag information identifying the data stored in the corresponding way associated with that prologue tag entry, wherein the control circuitry is configured, for each one of the one or more corresponding ways, to perform a prologue lookup in the prologue tag storage circuitry associated with that one of the one or more corresponding ways based on a prologue portion of the lookup tag information.
Clause 3. The apparatus of clause 2, wherein the control circuitry is responsive to the prologue lookup resulting in a prologue hit on a single way of the one or more corresponding ways, to trigger corresponding data associated with the lookup tag information to be accessed from the single way.
Clause 4. The apparatus of clause 3, wherein the control circuitry is responsive to the prologue lookup resulting in the prologue hit, to trigger ways of the one or more corresponding ways other than the single way to transition to the low power state.
Clause 5. The apparatus of any of clauses 2 to 4, wherein the control circuitry is configured to trigger the transition prior to completion of the prologue lookup.
Clause 6. The apparatus of any of clauses 2 to 5, wherein for a given data item, a combination of the preamble tag information and the prologue tag information uniquely identify the tag information for the given data item.
Clause 7. The apparatus of any of clauses 2 to 6, wherein the preamble lookup is performed during a sequentially first clock cycle and the prologue lookup is performed in a sequentially second clock cycle.
Clause 8. The apparatus of clause 7, wherein the first clock cycle and the second clock cycle are consecutive clock cycles.
Clause 9. The apparatus of clause 7, wherein the first clock cycle and the second clock cycle are non-consecutive clock cycles.
Clause 10. The apparatus of any of clauses 7 to 9, wherein the control circuitry is configured to trigger corresponding data associated with the lookup tag information to be read from the way in the sequentially second clock cycle.
Clause 11. The apparatus of any of clauses 7 to 10, wherein the control circuitry is configured to trigger the transition in the sequentially second clock cycle.
Clause 12. The apparatus of any preceding clause, wherein the storage circuitry is configured to trigger each way to transition into the low power state in response to a predetermined condition being met.
Clause 13. The apparatus of clause 12, wherein for a given way, the predetermined condition is met when the given way is not accessed for a predetermined number of clock cycles.
Clause 14. The apparatus of any preceding clause, wherein the apparatus is arranged as a cache.
Clause 15. The apparatus of clause 14, wherein the cache is a snoop filter.
Clause 16. The apparatus of any preceding clause, wherein the control circuitry is configured to trigger the transition of a given way from the low power state to the accessible state by modifying a power supply parameter associated with the given way.
Clause 17. A system comprising: the apparatus of any preceding clause, implemented in at least one packaged chip; at least one system component; and a board, wherein the at least one packaged chip and the at least one system component are assembled on the board.
Clause 18. A chip-containing product comprising the system of clause 17, wherein the system is assembled on a further board with at least one other product component.
Clause 19. A method of operating an apparatus comprising storage circuitry arranged as a set-associative structure having a plurality of ways, each of the plurality of ways operable in an accessible state in which data can be accessed and a low power state in which the data is retained in an inaccessible state, the method comprising: storing, in preamble tag storage circuitry, a plurality of preamble tag entries, each preamble tag entry associated with a corresponding way of the plurality of ways and comprising a subset of bits of tag information identifying the data stored in the corresponding way associated with that preamble tag entry; and in response to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, triggering a transition of the one or more corresponding ways to the accessible state, and retaining ways other than the one or more corresponding ways in the low power state.
Clause 20. A non-transitory computer-readable medium storing computer-readable code for fabrication of the apparatus of any of clauses 1 to 16.

What is claimed is:

1. An apparatus comprising:
storage circuitry arranged as a set-associative structure having a plurality of ways, each of the plurality of ways operable in an accessible state in which data can be accessed and a low power state in which the data is retained in an inaccessible state;
preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry; and
control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.

2. The apparatus of claim 1, comprising prologue tag storage circuitry associated with each corresponding way and configured to store prologue tag entries, each prologue tag entry comprising a further subset of bits of the tag information identifying the data stored in the corresponding way associated with that prologue tag entry,
wherein the control circuitry is configured, for each one of the one or more corresponding ways, to perform a prologue lookup in the prologue tag storage circuitry associated with that one of the one or more corresponding ways based on a prologue portion of the lookup tag information.

3. The apparatus of claim 2, wherein the control circuitry is responsive to the prologue lookup resulting in a prologue hit on a single way of the one or more corresponding ways, to trigger corresponding data associated with the lookup tag information to be accessed from the single way.

4. The apparatus of claim 3, wherein the control circuitry is responsive to the prologue lookup resulting in the prologue hit, to trigger ways of the one or more corresponding ways other than the single way to transition to the low power state.

5. The apparatus of claim 2, wherein the control circuitry is configured to trigger the transition prior to completion of the prologue lookup.

6. The apparatus of claim 2, wherein for a given data item, a combination of the preamble tag information and the prologue tag information uniquely identify the tag information for the given data item.

7. The apparatus of claim 2, wherein the preamble lookup is performed during a sequentially first clock cycle and the prologue lookup is performed in a sequentially second clock cycle.

8. The apparatus of claim 7, wherein the first clock cycle and the second clock cycle are consecutive clock cycles.

9. The apparatus of claim 7, wherein the first clock cycle and the second clock cycle are non-consecutive clock cycles.

10. The apparatus of claim 7, wherein the control circuitry is configured to trigger corresponding data associated with the lookup tag information to be read from the way in the sequentially second clock cycle.

11. The apparatus of claim 7, wherein the control circuitry is configured to trigger the transition in the sequentially second clock cycle.

12. The apparatus of claim 1, wherein the storage circuitry is configured to trigger each way to transition into the low power state in response to a predetermined condition being met.

13. The apparatus of claim 12, wherein for a given way, the predetermined condition is met when the given way is not accessed for a predetermined number of clock cycles.

14. The apparatus of claim 1, wherein the apparatus is arranged as a cache.

15. The apparatus of claim 14, wherein the cache is a snoop filter.

16. The apparatus of claim 1, wherein the control circuitry is configured to trigger the transition of a given way from the low power state to the accessible state by modifying a power supply parameter associated with the given way.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method of operating an apparatus comprising control circuitry and storage circuitry arranged as a set-associative structure having a plurality of ways, each of the plurality of ways operable in an accessible state in which data can be accessed and a low power state in which the data is retained in an inaccessible state, the method comprising:
storing, in preamble tag storage circuitry, a plurality of preamble tag entries, each preamble tag entry associated with a corresponding way of the plurality of ways and comprising a subset of bits of tag information identifying the data stored in the corresponding way associated with that preamble tag entry; and
in response to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, triggering a transition of the one or more corresponding ways to the accessible state, and retaining ways other than the one or more corresponding ways in the low power state.

20. A non-transitory computer-readable medium storing computer-readable code for fabrication of an apparatus comprising:
storage circuitry arranged as a set-associative structure having a plurality of ways, each of the plurality of ways operable in an accessible state in which data can be accessed and a low power state in which the data is retained in an inaccessible state;
preamble tag storage circuitry configured to store a plurality of preamble tag entries, each preamble tag entry associated with a corresponding way of the plurality of ways and comprising a subset of bits of tag information identifying the data stored in the corresponding way associated with that preamble tag entry; and
control circuitry responsive to receipt of lookup tag information to perform a preamble lookup in the preamble tag storage circuitry based on a preamble portion of the lookup tag information, wherein the control circuitry is responsive to the preamble lookup resulting in one or more preamble hits on one or more preamble tag entries identifying one or more corresponding ways, to trigger a transition of the one or more corresponding ways to the accessible state, and to retain ways other than the one or more corresponding ways in the low power state.
